(19) United States
(12) Patent Application Publication
(10) Pub. No.: US 2021/0197331 A1
(43) Pub. Date: Jul. 1, 2021

(54) MACHINE TOOL AND TOOL CHANGING METHOD

(71) Applicant: HONDA MOTOR CO., LTD., Tokyo (JP)

(72) Inventor: Takafumi Murakami, Tokyo (JP)

(21) Appl. No.: 17/128,261

(22) Filed: Dec. 21, 2020

(30) Foreign Application Priority Data
Dec. 27, 2019 (JP) 2019-238405

(51) Int. Cl. B23Q 3/155; G05B 19/4065

(52) U.S. Cl. CPC B23Q 3/15513; G05B 2219/50276; G05B 2219/37252; G05B 19/4065

(57) ABSTRACT

When the number of machining operations using a tool attached to a machining head of a machine tool has reached a predetermined number of machining operations for replacement, without a determination unit determining that an abnormality has occurred in the tool, then the tool is replaced with a replacement tool that is held in a tool magazine. Further, the tool removed from the machining head is returned to the tool magazine and stored as an auxiliary replacement tool. Then, if the determination unit determines that an abnormality has occurred in the replacement tool, the replacement tool is replaced with the auxiliary replacement tool.

### CROSS-REFERENCE TO RELATED APPLICATION

This application is based upon and claims the benefit of priority from Japanese Patent Application No. 2019-238405 filed on Dec. 27, 2019, the contents of which are incorporated herein by reference.

### BACKGROUND OF THE INVENTION

### Field of the Invention

The present invention relates to a machine tool including a machining head and a tool magazine, and to a tool changing method for replacing the tool attached to the machining head with a replacement tool that is held in the tool magazine.

### Description of the Related Art

As is well known, machine tools including a machining head to which a tool such as a drill, end mill, reamer, etc. is attached are used, for example, to perform machining operation on a workpiece in order to obtain a given structure. As described in Japanese Patent Publication No. 03-017615, such a tool is used for machining until it reaches its working limit (in other words, its life), and is then replaced with a replacement tool when reaching the working limit. The working limit is, for example, the number of machining operations or a machining time after which machining the workpiece with given accuracy is considered to be impossible (refer to Japanese Laid-Open Patent Publication No. 10-100033), which is obtained by preparatory tests. Replacement tools are usually stored in a tool magazine in advance and the tools are changed automatically by a tool changer.

Further, Japanese Patent Publication No. 60-001134 proposes to select a tool whose remaining life is longer than the estimated operating time and is the minimum from among tools of the same kind that were used for machining, in order to improve the operating rate of a machine tool.

### SUMMARY OF THE INVENTION

If an abnormality, such as chipping occurs, in a tool (or a replacement tool) before it reaches the limit number of machining operations, then the process has to use a larger number of tools than scheduled in order to accomplish a given number of machining operations. That is, it is becoming apparent that conventional machine tools require preparation of a large number of tools so as to deal with unexpected troubles, and it is therefore not easy to achieve cost reduction.

A main object of the present invention is to provide a machine tool capable of reducing the number of tools (or replacement tools) that are used to perform a given number of machining operations.

Another object of the present invention is to provide a tool changing method capable of reducing costs.

In order to achieve the objects above, an embodiment of the invention provides a machine tool including a machining head to which a tool is attached, and a tool magazine configured to hold a replacement tool of the same kind as the tool, the machine tool including:

a tool changer configured to replace the tool with the replacement tool; and

a determination unit configured to determine whether an abnormality has occurred in the tool attached to the machining head,

wherein, if a number of machining operations using the tool reaches a number of machining operations for replacement that is smaller than a predetermined limit number of machining operations, without the determination unit determining that an abnormality has occurred in the tool, then the tool changer replaces the tool with the replacement tool and also returns the tool removed from the machining head to the tool magazine as an auxiliary replacement tool, and

if the determination unit determines that an abnormality has occurred in the replacement tool before a number of machining operations using the replacement tool reaches the number of machining operations for replacement, then the tool changer replaces the replacement tool with the auxiliary replacement tool.

Another embodiment of the invention provides a tool changing method for replacing, by using a tool changer, a tool attached to a machining head of a machine tool with a replacement tool that is held in a tool magazine and is of the same kind as the tool, the tool changing method including:

causing the tool changer to replace the tool with the replacement tool and also return the tool removed from the machining head to the tool magazine as an auxiliary replacement tool, if a number of machining operations using the tool reaches a number of machining operations for replacement that is smaller than a predetermined limit number of machining operations, without a determination unit determining that an abnormality has occurred in the tool; and

causing the tool changer to replace the replacement tool with the auxiliary replacement tool if the determination unit determines that an abnormality has occurred in the replacement tool before a number of machining operations using the replacement tool reaches the number of machining operations for replacement.

According to the invention, a tool that was used for machining once is stored in the tool magazine as an auxiliary replacement tool. Then, if an abnormality of a tool is detected, the auxiliary replacement tool (i.e., the tool that was used for machining) is reused. Thus, the tool that was used for machining once but did not suffer any abnormality can be used for machining to its limit number of machining operations or a vicinity thereof.

This eliminates the need for preparation of an excessive number of new replacement tools. This makes it possible to reduce the number of tools and hence the cost.

Furthermore, the tools are replaced by a tool changer automatically. It is therefore not necessary to stop the machining operation of the machine tool in order to replace a broken tool with a replacement tool. That is, the machine tool can operate continuously. This enhances the manufacturing efficiency of machined products.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic front view illustrating main parts of a machine tool according to an embodiment of the invention;

FIG. 2 is a time chart illustrating a relationship between the number of machining operations and the timing of replacement in an example where five kinds of tools are held in a tool magazine;

FIG. 3 is a schematic flowchart illustrating a method for changing tools according to an embodiment of the invention; and

FIG. 4 is a time chart illustrating a relationship between the number of machining operations and the timing of replacement.

### DESCRIPTION OF THE PREFERRED EMBODIMENTS

Now, a tool changing method of the invention will be described in detail while referring to the accompanying drawings in conjunction with preferred embodiments in connection with a machine tool for implementing the method.

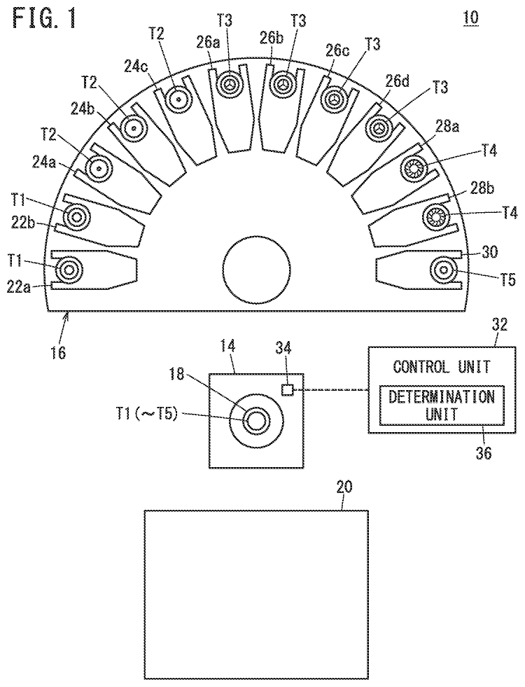

FIG. 1 is a schematic front view of main parts of a machine tool 10 according to an embodiment. The machine tool 10 includes a machining head 14, a tool magazine 16, and a tool changer not shown. Among these components, the machining head 14 has a machining spindle 18 that rotates under the action of a motor not shown, and one of tools T1 to T5 is attached to the tip of the machining spindle 18. The machining spindle 18 is rotationally driven to rotate the tool T1 to T5 together with it, to thereby perform a given machining operation on a workpiece 20.

The tool magazine 16 includes twelve slots 22a, 22b, 24a to 24c, 26a to 26d, 28a, 28b, and 30. The slots 22a, 22b each store a tool T1, and the slots 24a to 24c each store a tool T2. The slots 26a to 26d each store a tool T3, the slots 28a, 28b each store a tool T4, and the slot 30 stores a tool T5. That is, the tool magazine 16 holds, including tools for replacement, two tools T1, three tools T2, four tools T3, two tools T4, and one tool T5. As will be explained later, the total number of machining operations (the final number of machining operations) is set to 2400, for example. In this case, the numbers of the tools T1 to T5 held in the tool magazine 16 are all divisors of 2400.

The tools T1 to T5 are of different kinds, for performing different machining operations. Specific examples of the tools T1 to T5 can be drills, end mills, reamers, etc. All of the tools T1 to T5 may be drills, for example. In this case, drills for different machining operations are chosen, such as step drills and cross drills as the tools T1 and T2, respectively, for example.

The tool changer replaces the tool T1 attached to the machining spindle 18 of the machining head 14 with one of the tools T2 to T5 or a replacement tool T1. As mentioned earlier, a different kind of machining operation from that using the tool T1 can be performed by replacing the tool T1 with one of the tools T2 to T5. The tool changer will not be shown graphically and not described in detail, since it is well known to those skilled in the art.

The machine tool 10 further includes a control unit 32. For example, the control unit 32 includes a current measuring unit 34 for detecting the value of load current of the tools T1 to T5 held on the machining spindle 18, and a determination unit 36 for determining whether an abnormality is present on the basis of the load current value.

The determination unit 36 stores “numbers of machining operations for replacement” and “limit numbers of machining operations” respectively for the tools T1 to T5. The “limit number of machining operations” indicates the number of machining operations after which performing machining operation on the workpiece 20 with given accuracy is considered to be impossible. The “number of machining operations for replacement” is a given value that is smaller than the limit number of machining operations, and is set, for example, to about half the limit number of machining operations. In this embodiment, in order to facilitate understanding, the numbers of machining operations for replacement of the tools T1 to T5 are set to be 1300, 800, 600, 1200, and 2400, respectively.

Next, functions and effects of the machine tool 10 constructed basically as described above will be explained in relation to the tool changing method of the embodiment.

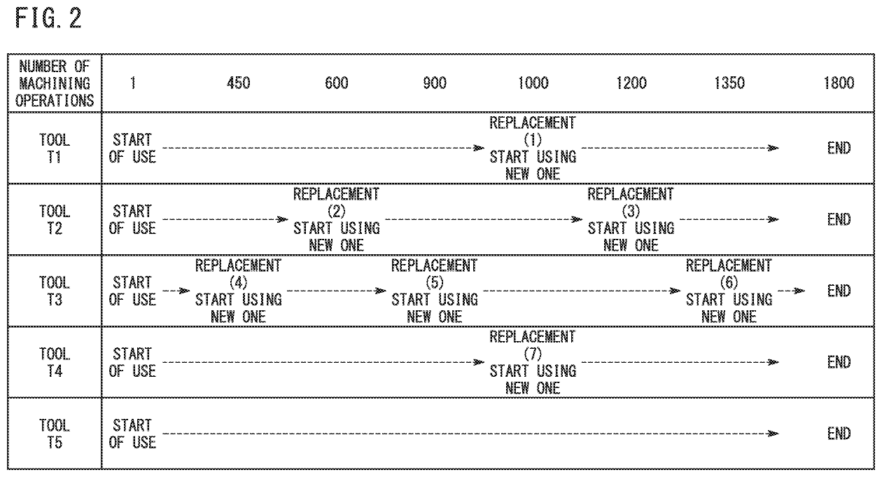

Suppose that the tool magazine 16 holds one tool T1, one tool T2, one tool T3, one tool T4, and one tool T5, and, as shown in FIG. 2, the tools T1 to T5 have each finished 1800 machining operations. Then, the tools T1 to T5 have been replaced once, twice, three times, once, and zero times, respectively. That is, in this case, it is necessary to replace the tools seven times to process 1800 workpieces 20. In this case, because no spare tools T1 to T5 are stored in the tool magazine 16, the worker has to stop the machining operation of the machine tool 10 temporarily and replace the tool that has reached its number of machining operations for replacement. This period is unproductive and so lengthens the time from the beginning of machining on the first workpiece 20 to the completion of machining on the last workpiece 20.

Furthermore, the machining operation has to be stopped also if some abnormality occurs. For example, if any of the tools T1 to T5 chips or snaps due to an abnormal load before it reaches the limit number of machining operations, then the machining operation has to be stopped in order to replace the tool to settle the accident.

In the embodiment, taking this problem into consideration, the numbers of machining operations for replacement respectively for the tools T1 to T5 are stored in the determination unit 36 in advance. Now, in order to facilitate understanding, an example will be described in which the total number of machining operations is smaller than the number of machining operations for replacement of the tool T5, and an abnormality has occurred in the tool T3 in the course of the machining operations.

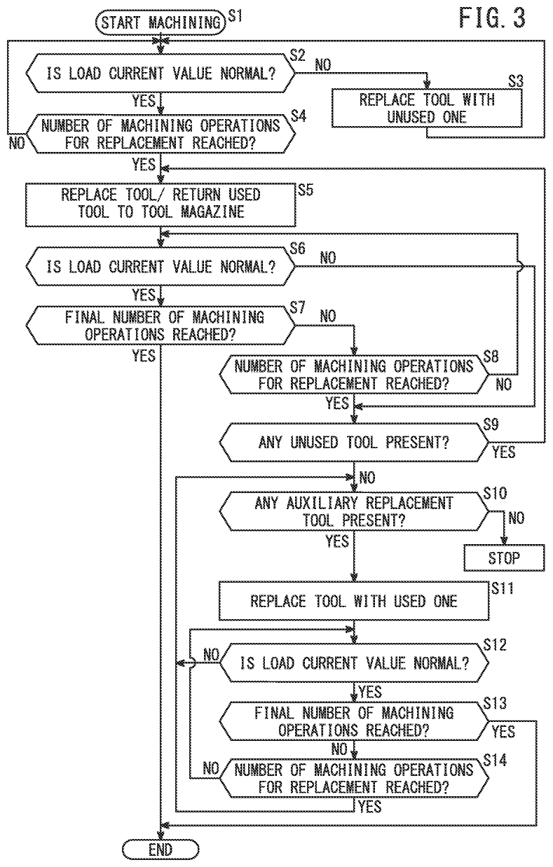

FIG. 3 is a schematic flowchart showing the tool changing method of the embodiment. The schematic flowchart mainly describes the replacement of the tool T3, but other tools T1, T2, and 14 are replaced according to the same process.

At the beginning of machining on the workpiece 20, the tool changer picks up the tool T1 from the slot 22a. When this tool T1 is attached to the machining spindle 18, the information is sent to the control unit 32 as a detection signal. Receiving this detection signal, the control unit 32 moves the workpiece 20 or the machining spindle 18 so as to place them close to each other. Further, the control unit 32 rotationally drives the motor to rotate the machining spindle 18 and the tool T1 together. The workpiece 20 is placed further closer to the machining spindle 18, and the rotating tool T1 performs a given machining operation on the workpiece 20. That is, the machining operations start.

During the machining operation by the tool T1, the current measuring unit 34 measures the load current value of the tool T1. The load current value stays substantially constant if the machining operation smoothly progresses without the tool T1 experiencing any abnormality like chipping or snapping. Accordingly, on the basis of the substantially constant load current value, the determination unit 36 determines that “the tool T1 has no abnormality and the machining operation is progressing”. That is, in this case, a determination of “no abnormality” is made and the machining operation is continued.

When the machining operation by the tool T1 is finished and the tool T1 is separated from the workpiece 20, then the tool changer removes the tool T1 from the machining spindle 18 under the control of the control unit 32, and returns it to the slot 22a. Further, the tool changer picks up the tool T2 from the slot 24a and attaches it to the machining spindle 18. After that, in the same way as described above, the rotating tool T2 performs a given machining operation on the workpiece 20 and the current measuring unit 34 measures the load current value of the tool T2.

When the machining operation by the tool T2 is finished and the tool T2 is separated from the workpiece 20, then the tool changer removes the tool T2 from the machining spindle 18 under the control of the control unit 32, and returns it to the slot 24a. Further, the tool changer picks up the tool T3 from the slot 26a and attaches it to the machining spindle 18. After that, in the same way, the rotating tool T3 performs a given machining operation on the workpiece 20 (step S1) and the current measuring unit 34 measures the load current value of the tool T3 (step S2). If the load current value is abnormal, that is, if the determination at step S2 is “NO”, then the process moves to step S3 to replace the tool T3 on the machining spindle 18 with the tool T3 in the slot 26b. On the other hand, if the load current value is substantially constant (“YES” at step S2), then the determination of “no abnormality” is made and the machining operation is continued.

When the machining operation by the tool T3 is finished, the tool T3 is returned to the slot 26a under the action of the tool changer, and the tool 14 in the slot 28a is picked up and attached to the machining spindle 18. After that, the rotating tool 14 performs a given machining operation on the workpiece 20 and the current measuring unit 34 measures the load current value of the tool 14.

Then, when the machining operation by the tool 14 is finished, the tool 14 is returned to the slot 28a under the action of the tool changer. After that, the tool T5 picked up from the slot 30 and attached to the machining spindle 18 performs a given machining operation on the workpiece 20. In this operation, too, the current measuring unit 34 measures the load current value of the tool T5.

The tools T1 to T5 process different portions in many cases, but two or more of the tools T1 to T5 may process the same portion. Also, the description above has illustrated an example in which the tool T1 (to T4) is replaced by the tool T2 (to T5) after performing one machining operation, but the tool T1 (to T4) may be replaced by the tool T2 (to T5) after performing multiple machining operations while changing the position of one workpiece 20. Alternatively, after a series of machining operations with the tools T1 to T5, the tools T1 to T5 may be used to process a different portion of the same workpiece 20.

When the machining operations with the tools T1 to T5 on one workpiece 20 finish, then the machined workpiece 20 is replaced with a new workpiece 20. The determination unit 36 makes the determination of “no abnormality” unless the load current value indicates an abnormal value. The machining operations are thus continued while changing the workpiece 20.

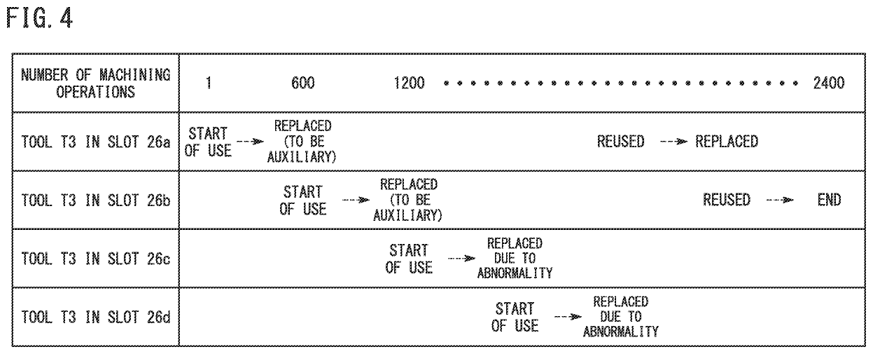

While the machining operations are being continued as described above, the numbers of machining operations performed by the tools T1 to T5 are measured, while measuring the load current value (steps S2, S4 in FIG. 3). As shown in the time chart of FIG. 4 that illustrates the replacement of the tool T3, if the machining operations are repeated based on the determination of “no abnormality”, then the number of machining operations by the tool T3 reaches 600 that corresponds to its number of machining operations for replacement (“YES” at step S4). In this case, in step S5, the tool T3, which has reached its number of machining operations for replacement, is returned to the slot 26a. Then, when the machining operation using the tool T3 is performed next time, the tool changer, under the control of the control unit 32, picks up the new tool T3 from the slot 26b and attaches it to the machining spindle 18. That is, the new tool T3 is used for machining after this. Needless to say, the current measuring unit 34 measures the load current value of the tool T3 during this operation (step S6). The machining operation is continued if the load current value is normal.

While the machining operation using the new tool T3 is being continued, the numbers of machining operations with the tools T1 to T5 are measured. Then, the number of machining operations with the tool T2 reaches 800 that corresponds to its number of machining operations for replacement. The tool changer returns to the slot 24a the tool T2 that has reached the number of machining operations for replacement. When the machining operation using the tool T2 is performed next time, the tool changer picks up the new tool T2 from the slot 24b and attaches it to the machining spindle 18. The new tool T2 is used for machining after this. Needless to say, in this operation, the current measuring unit 34 measures the load current value of the tool T2.

Then, the control unit 32 determines whether the number of machining operations has reached the final number of machining operations (step S7). The number of machining operations reaches 1200 before reaching the final number of machining operations, and so the tools T3, 14 reach their own numbers of machining operations for replacement (“NO” at step S7 and “YES” at step S8). Then, the tool changer goes back to step S5 via step S9, to return the tool T3 that has reached the number of machining operations for replacement, to the slot 26b, or to return the tool T4 to the slot 28a. Then, when the machining operations using the tools T3, T4 are performed next time, the tool changer picks up the new tool T3, T4 from the slot 26c, 28b and attaches it to the machining spindle 18. After this, the new tools T3, T4 are used for machining. In these operations, too, the current measuring unit 34 measures the load current value of the tool T3, T4. That is, steps S6 to S8 are executed.

If the load current value stays normal, the number of machining operations reaches 1800, which corresponds to the number of machining operations for replacement of the tool T3 (“YES” at step S8). The tool changer returns to the slot 26c the tool T3 that has reached the number of machining operations for replacement. When the machining operation using the tool T3 is performed next time, the new tool T3 is picked up from the slot 26d and attached to the machining spindle 18. That is, the process returns to step S5 via step S9, and the new tool T3 is used for machining after this. Then, the machining operations are continued as long as the load current value stays normal, and the number of machining operations reaches 2400 that corresponds to the final number of machining operations (“YES” at step S7). The machining operations thus end.

Now, for example, suppose that an abnormal load acts on the tool T3 that was picked up from the slot 26c, while the tool T3 is being used to machine the workpiece 20, and this tool T3 undergoes an abnormality such as chipping or snapping. In this case, the load current value of the tool T3 measured by the current measuring unit 34 becomes larger over the normal value (“NO” at step S6). This is because the frictional resistance between the broken tool T3 and the workpiece 20 becomes larger and so the value of current supplied to the tool T3 to rotate the tool T3 becomes larger.

On the basis of the detection signal generated by the current measuring unit 34, the determination unit 36 recognizes that the load current value has exceeded a given value. The determination unit 36 thus determines that “an abnormality has occurred in the tool T3 (the machining operation cannot be continued)”. In this case, the tool changer returns the tool T3 to the slot 26c under the control of the control unit 32. Further, at step S9, the control unit 32 determines “whether there is any unused tool T3”. In this case, the slot 26d stores an unused tool T3, and therefore the process returns to step S5 in FIG. 3. The tool changer then picks up the new tool T3 from the slot 26d and attaches it to the machining spindle 18. The new tool T3 is used for machining after this.

After that, if the load current value measured at step S6 stays normal, the number of machining operations of the new tool T3 reaches 600 after it was attached to the machining spindle 18 (in other words, after it was substituted for the previous tool T3 that was determined as abnormal), which corresponds to the number of machining operations for replacement (step S8). Then, while causing the tool changer to return the tool T3 to the slot 26d, the control unit 32 determines at step S9 “whether there is any unused tool T3”. In this case, no unused tool T3 is present and so the process moves to step S10.

Step S10 determines “whether there is any auxiliary, replacement tool T3 (that is, any tool T3 that was used for machining once). The slot 26a stores the tool T3 that was used once, and therefore the control unit 32 causes the tool changer to pick up the tool T3 from the slot 26a and attach it to the machining spindle 18 (step S11). This tool T3 is used for machining after this, and whether the load current value is normal or not is determined (step S12).

On the other hand, in the event that the load current value has become larger while the machining operation on the workpiece 20 by the tool T3 picked up from the slot 26d is being continued, the determination unit 36 determines that “an abnormality has occurred in the new tool T3” at step S6. In this case, too, the process proceeds through steps S10, S11. That is, under the control of the control unit 32, the tool changer returns the tool T3 to the slot 26d, and picks up the tool T3, which was used for machining once, from the slot 26a and attaches it to the machining spindle 18. This tool T3 is used for machining after this.

The tool T3 that was stored in the slot 26a can be reused despite the fact that it was used once, because it was replaced when it reached the number of machining operations for replacement that is smaller than the limit number of machining operations. The control unit 32 subtracts the number of machining operations for replacement from the limit number of machining operations and sets the same value as the value obtained by this subtraction, as a new number of machining operations for replacement. The new number of machining operations for replacement may be a value that is smaller than the value obtained by subtracting the number of machining operations for replacement from the limit number of machining operations. In short, the new number of machining operations for replacement is set equal to or less than the value obtained by subtracting the number of machining operations for replacement from the limit number of machining operations.

Then, the determination unit 36 keeps making the determination “no abnormality” as long as the load current values of the tools T1 to T5 stay normal (“YES” at step S12). The machining operations are thus continued while changing the workpiece 20. Needless to say, step S13 determines whether the number of machining operations has reached the final number of machining operations, and the machining operations finish when the final number of machining operations is reached.

On the other hand, when the tool T1 has reached the number of machining operations for replacement before the final number of machining operations is reached (that is, while the machining operations are being continued), then the tool changer replaces the tool T1 with a new one under the control of the control unit 32. That is, the tool changer returns the tool T1 that has reached the number of machining operations for replacement to the slot 22a. When the machining operation using the tool T1 is performed next time, the tool changer picks up the new tool T1 from the slot 22b and attaches it to the machining spindle 18. The new tool T1 is used for machining after this.

When the tool T3 that was picked up from the slot 26a has reached the new number of machining operations for replacement (“YES” at step S14), then the process returns to step S10. Then, in step S11, the control unit 32 causes the tool changer to return the tool T3 to the slot 26a, pick up the tool T3, which was used for machining once, from the slot 26b, and attach it to the machining spindle 18. Steps S12 to S14 are executed after that.

On the other hand, the load current value of the auxiliary replacement tool T3 picked up from the slot 26a may possibly become larger before the tool T3 reaches the number of machining operations for replacement. In this case, at step S12, the determination unit 36 determines that “an abnormality has occurred in the tool T3”. The process then proceeds to step S10 in the same way as described above. Then, in step S11, under the control action of the control unit 32, the tool changer returns the tool T3 to the slot 26a, picks up the tool T3 from the slot 26b, and attaches it to the machining spindle 18. After this, in either case, the tool T3 stored in the slot 26b is used for machining and steps S12 to S14 are executed.

The tool T3 stored in the slot 26b, too, can be reused despite the fact that it was used once, because it was replaced when it reached the number of machining operations for replacement that is smaller than the limit number of machining operations. The control unit 32 subtracts the number of machining operations for replacement from the limit number of machining operations and sets a value equal to or smaller than this value as a new number of machining operations for replacement.

On the other hand, if step S10 determines that “there is no auxiliary replacement tool T3”, then the machining operation of the machine tool 10 is stopped.

This procedure is performed in the same way also when an abnormal load current value is detected during machining operations using the tool T1, T2, T4. That is, a tool T1, T2, T4 that was used for machining once is used again for machining.

In this way, in the embodiment, the tools T1 to 14 that were used for machining once are stored in the tool magazine 16 as auxiliary replacement tools. Then, if an abnormality like chipping or snapping has occurred in any of the tools T1 to 14, then any of the tools T1 to 14 stored as auxiliary replacement tools (that were used for machining once) is reused. As a consequence, tools T1 to 14 that have not suffered any abnormalities are used for machining to the limit numbers of machining operations or vicinities thereof.

This eliminates the need for preparation of an excessive number of new replacement tools. In other words, the embodiment can reduce the number of tools. This enables cost reduction.

Furthermore, according to the embodiment, the tools T1 to T5 are replaced automatically by the tool changer, including occasions where an abnormality has occurred in any of the tools T1 to T5. Accordingly, it is not necessary to stop the machine tool 10 in order to replace the broken tool T1 to T5 with a new one. This allows the machine tool 10 to operate continuously, improving the manufacturing efficiency of machined products.

Moreover, the workers are not required to manually replace tools. In addition, the quality of machining is guaranteed until the load current value indicates an abnormal value. Therefore, there is no particular need for checkers to examine the quality of the machined products. This makes it possible to reduce manpower.

Then, the machining operations finish when the total number of machining operations reaches the predetermined number, i.e., 2400 times. As explained above, the total number of machining operations is 2400 and the numbers of the tools T1 to T5 held in the tool magazine 16 are all set to divisors of 2400. The numbers of machining operations for replacement of the tools T1 to T5 are set to divisors of 2400 accordingly. Consequently, when the machining operations finish and the operation of the machine tool 10 is stopped, all of the machine tools T1 to T5 in the slots 22a to 30 are replaced. In this way, setting the numbers of machining operations for replacement of the tools T1 to T5 to divisors of the total number of machining operations enables all of the tools T1 to T5 to be replaced when the operation of the machine tool 10 is stopped.

Thus, it is not necessary to replace any of the tools T1 to T5 while the machine tool 10 is in operation, unless an abnormality occurs. That is, it is possible to avoid situations where the operation of the machine tool 10 has to be stopped during the machining operations in order to replace some of the machine tools T1 to T5.

The present invention is not particularly limited to the embodiment described above, but can be modified in various manners without departing from the essence and gist of the invention.

For example, the description above has shown an example in which, if an abnormality of the tool T3 in the slot 26c is detected, it is replaced with the new tool t3 in the slot 26d. However, at this stage, the tool T3 may be replaced with the tool T3 in the slot 26a (an auxiliary replacement). In this case, step S9 and step S10 are exchanged.

Also, a vibration sensor may be used to detect vibrations of the tools T1 to T5, in place of detecting the load current values of the tools T1 to T5.

What is claimed is:

1. A machine tool including a machining head to which a tool is attached, and a tool magazine configured to hold a replacement tool of a same kind as the tool, the machine tool comprising:
a tool changer configured to replace the tool with the replacement tool; and
a determination unit configured to determine whether an abnormality has occurred in the tool attached to the machining head,
wherein, if a number of machining operations using the tool reaches a number of machining operations for replacement that is smaller than a predetermined limit number of machining operations, without the determination unit determining that an abnormality has occurred in the tool, then the tool changer replaces the tool with the replacement tool and also returns the tool removed from the machining head to the tool magazine as an auxiliary replacement tool, and
if the determination unit determines that an abnormality has occurred in the replacement tool before a number of machining operations using the replacement tool reaches the number of machining operations for replacement, then the tool changer replaces the replacement tool with the auxiliary replacement tool.

2. The machine tool according to claim 1, wherein, if a number of machining operations using the auxiliary replacement tool reaches a new number of machining operations for replacement that is equal to or smaller than the limit number of machining operations without the determination unit determining that an abnormality has occurred in the auxiliary replacement tool, then the machining operation using the auxiliary replacement tool is ended.

3. The machine tool according to claim 1, wherein a total number of the tool and the replacement tool of the same kind that are held in the tool magazine is set to a divisor of a total number of machining operations.

4. A tool changing method for replacing, by using a tool changer, a tool attached to a machining head of a machine tool with a replacement tool that is held in a tool magazine and is of a same kind as the tool, the tool changing method comprising:
causing the tool changer to replace the tool with the replacement tool and also return the tool removed from the machining head to the tool magazine as an auxiliary replacement tool, if a number of machining operations using the tool reaches a number of machining operations for replacement that is smaller than a predetermined limit number of machining operations, without a determination unit determining that an abnormality has occurred in the tool; and
causing the tool changer to replace the replacement tool with the auxiliary replacement tool if the determination unit determines that an abnormality has occurred in the replacement tool before a number of machining operations using the replacement tool reaches the number of machining operations for replacement.

5. The tool changing method according to claim 4, wherein, if a number of machining operations using the auxiliary replacement tool reaches a new number of machining operations for replacement that is equal to or smaller than the limit number of machining operations without the determination unit determining that an abnormality has occurred in the auxiliary replacement tool, then the machining operation using the auxiliary replacement tool is ended.

6. The tool changing method according to claim 4, wherein, if the number of machining operations using the replacement tool reaches the number of machining operations for replacement without the determination unit determining that an abnormality has occurred in the replacement tool, then the tool changer replaces the replacement tool with a new replacement tool and returns the replacement tool removed from the machining head to the tool magazine as a new auxiliary replacement tool.

7. The tool changing method according to claim 6, wherein, if a number of machining operations using the new replacement tool reaches the number of machining operations for replacement without the determination unit determining that an abnormality has occurred in the new replacement tool, then the machining operation using the new replacement tool is ended and the tool changer returns the new replacement tool to the tool magazine as another new auxiliary replacement tool.

8. The tool changing method according to claim 4, wherein the number of machining operations for replacement of the tool and the replacement tool of the same kind that are held in the tool magazine is set to a divisor of a total number of machining operations.
